(19) United States
(12) Patent Application Publication
(10) Pub. No.: US 2023/0038922 A1
(43) Pub. Date: Feb. 9, 2023

(54) Blockchain Implemented Data Hiding Solutions For Improvements In Secure Communication, Storage And Transmission Of Data

(71) Applicant: JAJ TECHNOLOGY PTE. LTD., Hamilton (NZ)

(72) Inventors: Alexander Louis Fauvel, Hamilton (NZ); Remie Merdegia Ramos, Hamilton (NZ)

(21) Appl. No.: 17/787,082

(22) PCT Filed: Dec. 18, 2020
(86) PCT No.: PCT/IB2020/062155

§ 371 Date: Jun. 17, 2022

(30) Foreign Application Priority Data
Dec. 18, 2019 (GB) 1918729.3

(51) Int. Cl. H04L 9/00; H04L 9/08; H04L 9/32

(52) U.S. Cl. CPC H04L 9/50; H04L 9/085; H04L 9/3239

(57) ABSTRACT

Embodiments of the disclosure provide blockchain-implemented methods and systems for secure data transfer and/or storage via the use of data hiding (e.g. steganography algorithms, watermarking etc). In accordance with one aspect, a data hiding algorithm is applied multiple times to a portion of secret data to embed it in a cover file. This constructs layers of hidden data, e.g. secret data hidden in an image that is then used as secret data in a further cover file and so on. Each layer can incorporate encryption and authentication techniques to further enhance security. The final layer or a compressed version is provided within a blockchain transaction. Additionally or alternatively, the secret data can be split into a plurality of shares. This can be achieved using a splitting scheme such as, for example Shamir's Secret Sharing Scheme. Different shares of the secret data can then be encrypted before being hidden within a cover file. Different cover files can hide different shares, preferably each share being provided on the blockchain in a different transaction. To access the secret data, all of the cover files need to be identified and accessed from the blockchain, the relevant steganography, compression and encryption technique(s) applied to each, and then the secret data is reconstructed.

### TECHNICAL FIELD

This invention relates generally to secure data communication, encryption, compression and steganography, and also to blockchain-related technologies. In particular, it relates to the ability to hide data inside other data and files such as, for example, image or text files. It also couples the ability to compress and then decompress the files without loss of the encoded data. The invention is particularly suited, but not limited to, use in relation to secure transmission of data via a blockchain transaction.

### BACKGROUND

Steganography is the practice of hiding data inside another portion of data. Hidden data may be confidential, sensitive or secret, and the other data may be non-secret. The non-secret data may be referred to as the “cover text” and the secret data may be referred to as the “hidden text”. Concealment of the hidden text within the cover text facilitates its secure, undetected communication because even if the encoded cover text is intercepted by an unauthorised party they remain unaware of the hidden text.

In the digital era, the cover text can be any type of electronic data such as a text document, image or other type of digital file or data stream. The hidden text can also take any form such as text, image, code, audio/media content and so on, and is embedded in the cover text in such a way that its presence is not detectable or at least easily noticeable. The hidden content may be obfuscated in some way e.g. via the use of cryptography to further enhance security should its presence be detected.

In one common use case, steganography (i.e. a form of encoding a hidden or visible form of identifier on the image or media) may be used by content publishers to hide a trademark or other indicator into content as a watermark which can serve as evidence in the event of unauthorised copying. In other cases, a text file or message might be embedded into an image by altering the alpha channel or colour of pixels in the image such that the differences are difficult to distinguish. Other known uses are the establishment of covert communication channels between participating parties.

In brief, a steganography technique may involve the steps of encoding and encrypting the hidden text, inserting it into the cover text, maintaining a record of where and how in the cover text the hidden text is stored, transmission of the cover text with its embedded hidden text, and subsequent extraction and decryption of the hidden text by the authorised recipient. For example, U.S. Pat. No. 8,527,779 discloses a method and apparatus of performing distributed steganography of a data message. There are many known ways to perform the encryption, insertion and extraction steps, and the person skilled in the art will appreciate that any suitable method or technique could be employed for these purposes.

Compression techniques are also known, and can be used to advantage when storing and transmitting data, in particular large data files such as media content etc. Compression is the technique of removing repeated data from a data set so as to reduce its size. It is this reduced dataset that is then saved in memory or transmitted over an electronic network so that when it is retrieved and decompressed the original data set is fully restored. These methods do not lose any data, and can be used in conjunction with any steganographic process.

The transmission step can be performed in any known manner such as, for example, via text message, email, download from a remote site across a network etc. However, in recent years, a relatively new platform known as the blockchain has been explored for secure transmission of data. This includes techniques for embedding data in a blockchain transaction (TX) itself, or a pointer to data stored off-chain. The use of the blockchain as a reliable and secure communication vehicle provides numerous technical advantages such as an immutable, timestamped record of activities which are cryptographically enforced via the blockchain protocol and the peer-to-peer network nodes which implement it. Some advantages of using the blockchain as a vehicle for a covert communication channel are discussed in Juha Partala, “Provably Secure cover Communication on Blockchain”, Cryptography 2018, 2, 18; doi:10.3390/cryptography2030018 Others have investigated the use of steganography to embed a blockchain transaction in an image e.g.:
JP Buntinx, “SONIC Releases TimeVortex, Hiding Encrypted Transactions Using Steganography” Digital Money Times, Sep. 24 2014, https://digitalmoneytimes.com/sonic-releases-timevortex-hiding-encrypted-transactions-using-steganography/
In 2017, a challenge was published to explore the combination of steganography techniques and blockchain technologies: yours.org/content/angel-funding-project-1-3d4b0cf87d9e. The challenge involved using a smart phone to take a photograph, embedding a Bitcoin transaction into that image using steganography render the transaction undetectable
Jamie Redman, “Hiding Bitcoin Cash in Pictures With the New Pixel Wallet App”, Aug. 22 2018, Bitcoin.com, https:1/news.bitcoin.com/hiding-bitcoin-cash-in-pictures-with-the-new-pixel-wallet-app/

These examples illustrate the desire for secure communication of data using steganography and, in particular, harnessing the blockchain for further enhanced security and assurance of data integrity and technical advantages such as a platform for (public) attestation of the information submitted to a service In information security it is always assumed that encryption is insecure since variations in its implementation may inadvertently expose methods to unencrypt the information either with a targeted attack or leaked keys. Steganography can mitigate these issues since a would-be attacker does not have access to the encrypted text. Due to the nature of a blockchain and its associated protocol such as Bitcoin, being a public network, any information placed into a transaction (Tx) is broadcast to all participants. Simple encryption techniques are not enough to guarantee the security of the plaintext protected by the encryption algorithm. A benefit of the blockchain is that it gives data a publicly available audit trail that can be queried by any entity. The use of steganography in conjunction with encryption would allow the private and sensitive data to be propagated across the blockchain network, inheriting this auditable characteristic without exposing the encrypted text to any number of potential attacks.

However, the examples listed above relate to the use of steganography for putting blockchain transactions inside images. In other cases, steganography has been explored for hiding secret text within images that are stored off-chain and simply referred to or referenced from a transaction on the blockchain.

However, the inverse scenario of placing images comprising hidden texts within transactions (TXs) that are on the blockchain poses technical challenges. Scalability of the blockchain has been debated and there is scepticism that blockchain transactions can be used to transport large volumes of data such as images. Thus, it is not conventional or intuitive to combine blockchain technologies with image-based steganography techniques due to the technical difficulties of accommodating the encoded cover text within a size-restricted blockchain transaction and/or on a blockchain that is formed in accordance with a protocol that imposes a block size limit.

Thus, it would be advantageous to be able to enhance and improve the level of security provided by existing techniques for data transmission, to ensure controlled access to sensitive resources/data and also mitigate unauthorised access. An improved solution has now been devised which provides at least, but not exclusively, these advantages.

### SUMMARY

Thus, in accordance with the present disclosure there are provided systems and methods as defined in the appended claims.

Herein, the phrases “secret data” or “hidden data” are intended to include any type of sensitive or access controlled data. It may be data which a user wishes to store or send to a recipient in a disguised or obscured manner, for example by masking it or making it more difficult to detect the presence of the secret data. The secret data may be or may comprise sensitive or confidential data, or may be/comprise a digital watermark, or an identifier or tag, a label of origin or provenance, an audit marker, a date/timestamp, a serial number etc. It does not need to be in the form of textual data, but could be an image, a pattern or a colour, an audio file, an executable, a digital token or tokenised asset, for example.

Also herein, the phrase “data hiding algorithm” is intended to cover and include any algorithm or technique which can be applied to data to at least partially conceal or obscure its presence in a cover file. This includes, for example, steganography, watermarking, printer steganography, etc. Hereafter, the term “steganography” will be used to cover and include all data hiding techniques for ease of reference. “Concealing” or “hiding” is not intended to mean that the hidden, secret data must be completely invisible to the naked eye. It is intended to mean, as would be understood by the person skilled in the art of steganography, that the secret data is more difficult to detect with the naked eye and/or by machine because it is incorporated into something else, and therefore its presence is more difficult to discern than if it was simply stored or transmitted on its own, in isolation from a cover. Thus, the hidden (i.e. secret) text may or may not be visible to the naked eye.

Embodiments of the disclosure described and claimed below may provide improved security, data hiding, steganography and/or access control methods/systems; additionally or alternatively, they may provide improved methods and systems for: secure communication, storage and/or transmission of data; establishment of and communication/transmission of data via a communication channel, which may or may not be a secure covert communication channel; and/or blockchain-implemented data communication. In accordance with the disclosure there may be method(s) and system(s) as described and claimed herein. An embodiment of the disclosure may be provided which comprises the steps of: using a steganography algorithm to embed a portion of data within a cover file to provide an altered/encoded cover file; and using the same or a different steganography algorithm to embed the altered cover file within a further cover file to provide a further encoded/altered cover file.

Additionally, or alternatively, an embodiment of the disclosure may be provided which comprises the steps of splitting a portion of data into a plurality of shares; using a steganography algorithm to embed one, some or all of the shares into at least one cover text. Preferably, each share is embedded into a separate, respective cover text or instance of a cover text e.g. different instances of the same or different image file.

In other embodiments, the splitting and further embedding steps may be used within the same method, before or after each other, in various combinations. For example, the secret data may be split into shares; two shares may then be embedded into separate cover files to provide two encoded versions of the cover files; a steganography algorithm may then be used to embed one of the encoded cover files into the other encoded cover file, or a different cover file, to provide a further encoded cover file. The steganography algorithm(s) used to encode the cover files may subsequently be used to decode them, and arrive back at the original data shares. One or more of the encoded cover texts may be provided in a blockchain transaction. Other encoding/encryption techniques may also be used in conjunction with the above steps, and applied to the hidden data and/or cover texts, before or after application of the steganography algorithm(s). Data compression and decompression techniques may also be used.

Thus, the disclosure may provide a computer-implemented method for (secure) transfer and/or storage of a portion of (secret) data comprising the step of:

hiding (embedding) the data in a cover text. The cover text may serve as a transport vehicle into which the data is inserted. The cover text may be altered, reconfigured or modified such that it comprises the portion of data. The data may be referred to as “secret data”. The data may be obfuscated, hashed or encrypted in some way prior to embedding it within the cover text. The data may be embedded within the cover text by using or applying a steganography algorithm. Application of the steganography algorithm results in or provides an altered, adapted version of the cover text. This may be referred to as the “encoded cover text” or “altered cover text”.

The method may comprise the step of using a data hiding (steganography) algorithm to embed the encoded cover text in at least one further cover text to provide at least one further encoded cover text; the encoded and/or further encoded cover text may be encoded, obfuscated, hashed or encrypted in some way.

The method may comprise the step of providing the at least one further encoded cover text in a blockchain transaction. The blockchain may be submitted to a blockchain network and/or added to a blockchain (ledger). The blockchain may be any variation of the Bitcoin protocol or other blockchain protocol. The blockchain may be formed or implemented in accordance with a protocol which specifies or imposes a size limit on transactions and/or blocks that may be formed or utilised with the blockchain.

Additionally or alternatively, there may be provided a method of:

using a data hiding (steganography) algorithm or process to embed/hide the data in a cover text; and

providing the encoded cover text in a transaction on a blockchain. The cover text and/or data may be compressed and/or encrypted before or after the data is embedded/hidden in the cover text. In a preferred embodiment, this may be performed before the data is written to the blockchain or provided to a blockchain network. We may use the term “encrypted” herein to distinguish between data which has been processed to hide, disguise or obscure its readability e.g. via encryption, hashing etc., and a cover text which has been “encoded” so as to comprise a secret message via the application of a steganography technique.

Additionally, or alternatively, there may be provided a computer-implemented method for secure transfer and/or storage of secret data hidden in an encoded cover text. The method may comprise the steps:
using a data hiding (steganography) algorithm to embed the encoded cover text in at
   least one further cover text to provide at least one further encoded cover text;
and
providing the at least one further encoded cover text in a blockchain transaction.

This may substantially be as described in the “image in image steganography” section below, and may relate to encoding aspects of the disclosure.

Herein, the secret data may comprise any type of digital data or content, in any format. The cover text (or “file”) may be of any suitable type including but not limited to a text file, still or moving image, data stream, audio, tokenised asset etc. The data hiding (steganography) algorithm may be any such suitable algorithm known in the art.

The method may further comprise the step of:

submitting the blockchain transaction to a blockchain network. The blockchain may be any variation of the Bitcoin protocol or other blockchain protocol. The blockchain may be formed or implemented in accordance with a protocol which specifies or imposes a size limit on transactions and/or blocks that may be formed or utilised with the blockchain.

The method may further comprise the step of:
associating a verification element with the secret data, first cover text and/or at least one further cover text to require provision of the verification element before access is granted.

The method may further comprise the step of:
encrypting the secret data, the cover text, the first encoded cover text, the at least one further cover text and/or the at least one further encoded cover text prior to using the steganography algorithm.

The encryption can be performed using any suitable encryption technique or algorithm known in the art.

The method may further comprise the step of:
accessing the at least one further encoded cover text from a/the blockchain transaction;
using the same or a different data hiding (steganography) algorithm to decode the first or the further encoded cover text;
and/or
providing the verification element to gain access to the secret data, first cover text and/or at least one further cover text.

Preferably, the secret data is provided in the blockchain transaction (within the encoded cover text):
i) as a portion of metadata; this may be provided in the transaction in any known manner; and/or
ii) after an OP_PUSHDATA instruction, or OP_RETURN instruction or a script opcode that marks a transaction output (UTXO) as invalid; and/or
iii) as a reference to an off-blockchain resource; and/or
iv) as a tokenised digital entity.

The method(s) may comprise the step of applying a (data) compression algorithm to the hidden text, cover text, the encoded cover text, the at least one further cover text and/or the at least one further encoded cover text. The compression algorithm may reduce the size of the hidden text, cover text, the encoded cover text, the at least one further cover text and/or the at least one further encoded cover text. It may remove repeated and/or redundant data from the text(s). Any suitable compression technique may be utilised. This provides the advantage that fewer resources are required for storage on and off the blockchain, and for transmission. For data stored on the blockchain, where blockchain protocols may impose limits on the amount of data that can be stored in transactions and/or blocks, this may be advantageous. The compression (and subsequent decompression) algorithm may be applied before or after an encoding/decoding step, and prior to transmission of the transaction to the blockchain network. “Decoding” may refer to the use of a steganography algorithm to extract or provide a secret message from an encoded cover text.

Additionally, or alternatively, the disclosure provides: a computer-implemented method for secure transfer and/or storage of secret data hidden in an encoded cover text of a blockchain transaction; the method may comprise the steps:
using a data hiding (steganography) algorithm to decode the encoded cover text and provide a decoded cover text;
and
using the same or another data hiding (steganography) algorithm to decode the decoded cover text to provide the secret data or a further decoded cover text.

As with the embodiments mentioned above, this may substantially be as described in the “image in image steganography” section below, and may relate to decoding aspects of the disclosure.

The method may further comprise the step of:
accessing the encoded cover text from the blockchain transaction;
providing a verification element to gain access to the secret data, encoded cover text, decoded cover text and/or at least one further decoded cover text;
and/or
decrypting the secret data, the encoded cover text, the decoded cover text and/or the at least one further decoded cover text prior to using the data hiding (steganography)algorithm.

Preferably, the secret data is provided (within the encoded cover text) in the blockchain transaction:
i) as a portion of metadata;
ii) after an OP_PUSHDATA instruction, or OP_RETURN instruction or a script opcode that marks a transaction output (UTXO) as invalid;
and/or
iii) as a reference to an off-blockchain resource.

The method may comprise the step of applying a decompression algorithm to the hidden text, encoded cover text, the decoded cover text, and/or the further decoded cover text.

This may be performed to reverse a compression algorithm which may have been applied to the hidden text, encoded cover text, the decoded cover text, and/or the further decoded cover text in a previous step.

Additionally, or alternatively, the disclosure provides a computer-implemented method for secure transfer and/or storage of (secret) data. The method may comprise the steps:
splitting the data into a plurality of shares;
using at least one data hiding (steganography) algorithm to embed at least two of the plurality of shares in at least one cover text;
providing the at least one cover text in at least one blockchain transaction.

This may be substantially as described below in the section relating to “split image steganography”. The splitting step can be performed using any known share splitting technique such as, for example but not limited to, Shamir's Secret Sharing Scheme. As above, the cover text/file and or secret data can take a variety of forms or formats. Two or more shares may be provided within the same cover text, or shares may be provided within respective, separate cover texts.

The method may further comprise the step of: storing, in a repository: data relating to the secret data, the plurality of shares, the at least one blockchain transaction and or access permissions for the plurality of shares. The repository may be any suitable form of computer-based storage facility including a database, Distributed Hash Table, ledger file system etc.

The method may further comprise the step of encrypting at least one of the plurality of shares. Any suitable, known encryption algorithm may be used.

The method may further comprise the step of:
associating at least one verification element with at least one of the plurality of shares of the secret data and or at least one cover text to require provision of the verification element before access is granted. The verification element can comprise any known, suitable form as explained above.

The method may comprise the step of applying a compression/decompression algorithm to the at least one cover text.

The method may further comprise the step of generating or obtaining the secret data by:
i) obtaining or accessing the at least one (encoded) cover text from the at least one blockchain transaction;
ii) using the at least one data hiding (steganography) algorithm to decode the at least one encoded cover text to provide the at least two shares; and/or
iii) reconstructing the secret data from the at least two shares.

The disclosure also provides a system, comprising:
a processor; and
memory including executable instructions that, as a result of execution by the processor, causes the system to perform any embodiment of any of the computer-implemented methods described herein.

The disclosure also provides a non-transitory computer-readable storage medium having stored thereon executable instructions that, as a result of being executed by a processor of a computer system, cause the computer system to at least perform an embodiment of any of the computer-implemented methods described herein.

One or more feature(s) mentioned in relation to one aspect or embodiment may be applied to other aspect(s) or embodiment(s) of the disclosure. These and other aspects of the present invention will be apparent from and elucidated with reference to, the embodiment described herein. An embodiment of the present invention will now be described, by way of example only, and with reference to the accompany drawings, in which:

### BRIEF DESCRIPTION OF THE DRAWINGS

FIGS. 1a and 1b show stages of a known, illustrative use of steganography for watermarking a data file.

FIG. 2 illustrates an embodiment of the invention in which an encoded image is used as data for the input to the next iteration of encoding, each level being protected by a verification mechanism such as password. This enables a “picture in picture” form of secure transfer.

FIG. 2a shows the embodiment of FIG. 2 with the further encoded steganography text 2a (comprising steganography text 1a embedded within a further cover file) being provided to a blockchain transaction 6.

FIG. 3 illustrates an embodiment of the disclosure in which hidden data is split across multiple images. The encoding and decoding processes are illustrated.

FIGS. 4a and 4b illustrate a system arranged in accordance with an example embodiment of the disclosure, and the flow of data between system components. The encoding process 30 is shown in FIG. 4a and decoding process is illustrated in FIG. 4b.

FIGS. 5a and 5b show the use of compression in combination with embodiments of the present disclosure. FIGS. 5a and 5b provide an overview of how an image can be compressed and uploaded to a blockchain, and/or downloaded in compressed form from a blockchain, unlocked and decompressed to arrive back at its original form.

FIG. 6 is a schematic diagram illustrates a computing environment in which various embodiments can be implemented.

### DESCRIPTION OF ILLUSTRATIVE EMBODIMENTS

Herein, the terms “cover file” or “cover text” may be used interchangeably and are intended to include data streams as well as digital files. The term “cover text” may include images, video, audio etc and is not intended to be restricted to textual content. The cover file can be any digital entity which serves as a vehicle or medium for transmitting and concealing the secret data. The terms “encoded cover file/text” or “embedded cover file/text” or “altered cover file/text” are intended to mean a cover file or text which has been adapted using a steganography technique so as to comprise the (potentially encrypted/encoded) secret data. We will use the term “steganography” instead of “data hiding” for convenience as explained above but they are intended to be used interchangeably.

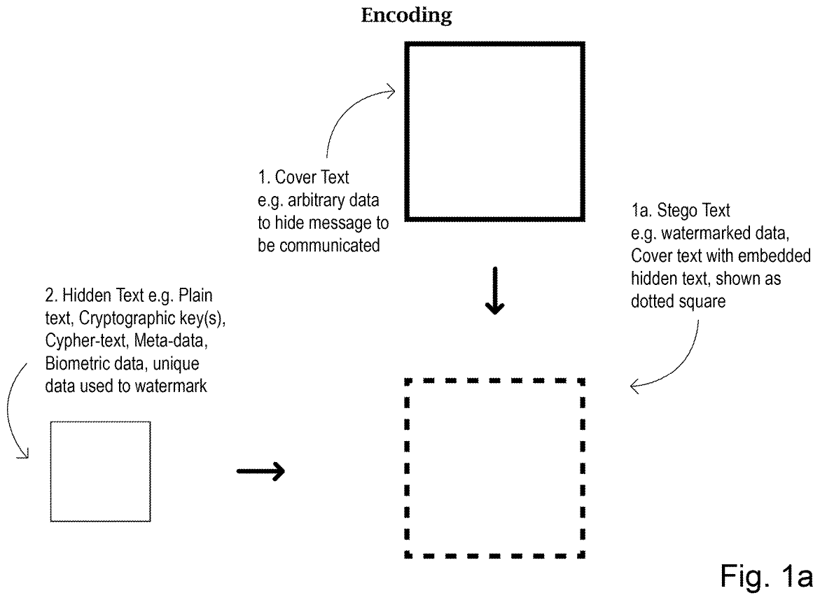

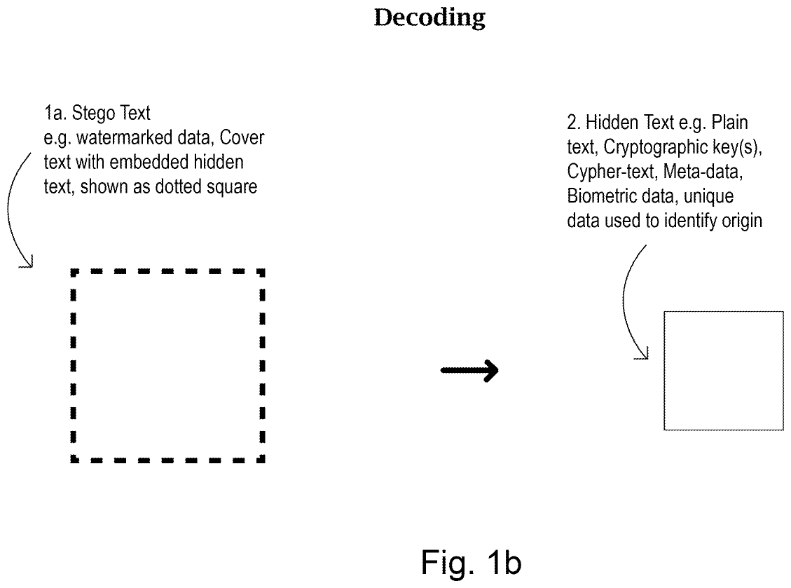

As explained above and illustrated in FIGS. 1a and 1b, steganography is a well-known and understood method which can be used, for example, for watermarking a digital file (cover text) 1 with a unique piece of data (hidden text) 2. The unique, hidden data 2 can then be extracted at a later date and used to identify or verify the origin of the digital cover text file 1. The hidden text 2 is optionally encoded/encrypted. It is then embedded and concealed within the cover text 1 and shown by item 1a in FIG. 1a, in which the hidden text is shown as the dotted box within the altered (encoded) cover text 1a. This works by adjusting the original file 1 in a specific way that the hidden watermark 2 is undetectable, or at least more difficult to detect, unless one knows the exact method used to obfuscate the unique hidden text 2. This method of encoding is kept secret so that it is secure and cannot be reverse-engineered. This encoding algorithm is then also used for decoding and/or extracting the hidden watermark 2, as shown in FIG. 1b.

There are various encoding algorithms known in the art, any of which can be used in conjunction with embodiments of the present disclosure for embedding the secret data within the cover file. The disclosure is not limited in this regard. Other uses and applications of steganography are known. These include, but are not limited to, secure transmission and/or storage of secret/sensitive data which need to be protected from unauthorised access, and shared across communications which may be vulnerable to eavesdroppers. Steganography methods may involve the use of cryptographic keys for encoding the secret data within the cover file.

For the sake of clarity and convenience, we shall refer herein to the method used for embedding/hiding the secret data in the cover text as the “stego algorithm” or “steganography algorithm” to distinguish it from other encoding methods that may be used for cryptographic or other security purposes in conjunction with the present disclosure.

Other encoding algorithms used by the disclosure for purposes other than embedding the secret data may be referred to simply as “encoding algorithms”.

Embodiments of the present disclosure utilise and improve upon this known approach to input sensitive data into images and/or other data files/streams. These can then be used to securely convey and/or store sensitive and private information via a public, immutable blockchain. This can be beneficial, for example, to comply with data regulations in various territories, or in situations where anonymity or pseudonymity of origin is required or desired, or where data security and controlled access is desired. To ensure that no one other than an authorised party is able to access the sensitive data, a password or other verification mechanism may also be used to protect and subsequently extract the data.

Advantageously, the immutable nature of the blockchain provides a technical advantage which previous arrangement fail to provide. If a mutable storage/transmission medium eg a database is used instead for sharing the encoded data, the process becomes less secure and unreliable, as moving a file or alteration of any kind could result in loss of all secret data or, at least render it irrecoverable. This problem, and others, is overcome by use of the blockchain. Although the concept of using steganography in combination with a blockchain has been explored before, embodiments of the present disclosure can be used to provide even further security for protection of sensitive data via the use of images as cover texts on the blockchain. Blockchain transactions are not considered suitable mediums for the incorporation of images due to the amount of data storage required, and so the combination of steganography, images as cover texts, and the use of blockchain transactions as a transmission vehicle represents a technical advance that runs counter to conventional understanding and provides numerous beneficial effects.

In accordance with one or more embodiments of the disclosure, the secret data is any type, form or format of data that needs to be protected from unauthorised viewing or access. It may comprise one, some or all of the following, although this list is not intended to be exhaustive and the secret data may comprise others not listed below:
Data relating to, or associated with, an individual or group of individuals eg identification or “know your client” data, account-related data, medically-related data and/or personal data;
Financial data such as account information, payment information, invoice information etc;
Cryptocurrency-related data including, but not limited to, a blockchain transaction or data relating to a blockchain transaction;
Verification data/element such as password, PIN, identifier, cryptographic key, biometric data etc
Device/vehicle/machine related data
Legally-oriented data e.g. relating to a contract, agreement or evidence

Aspects of the disclosure described below can be used in isolation or in combination, depending upon the context in which the implementation is utilised and the degree of security required to protect the secret, hidden text. These embodiments facilitate the use of steganography split between multiple, different sources (e.g. images) and/or performing steganography more than once to provide multiple, security-enforced access levels to encoded versions of the secret data.

### 1. Picture-In-Picture Steganography

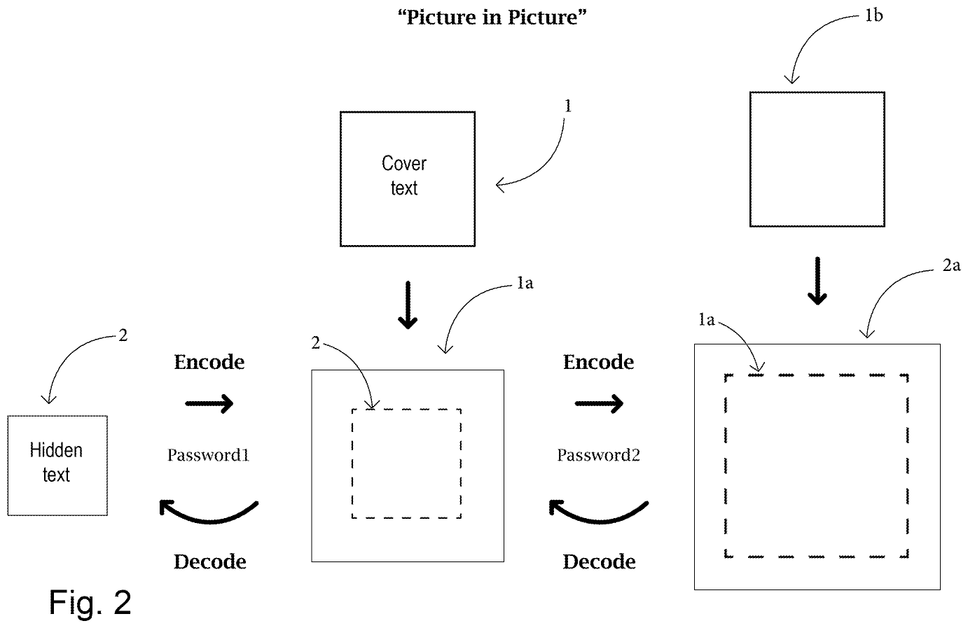

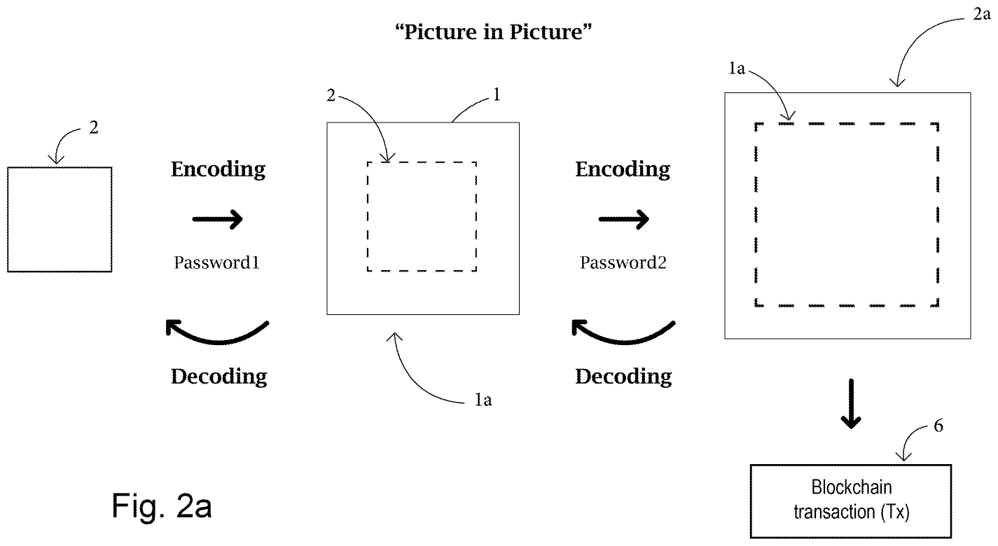

In accordance with an illustrative embodiment of the disclosure, a security technique is provided as illustrated in FIGS. 2 and 2a in which layers of altered cover files are constructed.

Turning to FIG. 2, a secret 2 is hidden in a cover file 1 using a steganography algorithm. The resulting steganography file/text is shown as box 1a in FIG. 2, with the secret data 2 shown as a dotted-line square inside it. This steganography text 1a, with the embedded secret 2 hidden inside it, is then encoded using a steganography algorithm and is itself then used as a secret to be input into a further cover file, thus producing a further steganography text shown in FIG. 2 as box 2a. Therefore, the first steganography text 1a becomes the hidden text shown as a dotted lined box inside the second steganography text 2a. The original hidden text 2 is buried within steganography text 1a which is then buried within steganography text 2a. In other words, the secret 2 is hidden within an image 1a inside a further image 2a.

This can be repeated as many times as required, according to security needs. In this way, multiple “layers” of steganography can be provided. Each additional layer heightens security as it requires more time, effort and resources to access/unlock each layer. In some embodiments, the secret data may be encoded with an encoding algorithm before and/or after it is embedded into the cover file using a steganography algorithm.

In some embodiments, the same steganography and/or encoding algorithm may be used for generating each, some or all of the “layers”. In other words, the same encoding and/or steganography algorithm may be used more than once during the process. In other embodiments, a given steganography/encoding algorithm may be used only once, and at least one other steganography/encoding algorithm may be used for one or more other iterations of a step of the disclosed method(s).

Each layer may (or may not) utilise a verification mechanism which requires successful verification by a user before access is provided to the secret data for that layer. In a preferred embodiment, each layer requires a different, unique verification element to be provided relative to the other layer(s). The verification element may require the use of a password or some other identifier eg PIN, biometric input etc. The required verification element may be selected or predetermined by an operator (user or administrator) of the disclosure. Additionally or alternatively, encryption may be used to obscure the secret text at one or more layers.

A non-limiting and non-exhaustive summary of steps which may be included in this approach, is provided as follows and with reference to the accompanying figures:
1. Secret data (“hidden text”) 2 is encoded using any suitable and chosen encoding technique (i.e. using an “encoding algorithm”). This might be a cryptographic technique as known to the skilled person; in one implementation, the secret data may be hashed and/or cryptographically encrypted. For illustrative purposes, password1 may be used in the encoding process.
2. The encoded secret data 2 is embedded in another portion of data (cover file 1) to provide an altered, encoded cover file (steganography text) 1a which comprises the concealed secret data 2;
   this is performed using a “steganography algorithm”;
3. This altered cover file 1a is then encoded in association with a further encoding mechanism e.g. password2 (using the same or a different encoding algorithm) and is used as concealed input to the next iteration/layer of security (using the same or another steganography algorithm) such that previously encoded steganography file 1a is now embedded as secret data within further cover file 1b, resulting in a new altered cover file 2a; thus, the original secret data is buried within layers of different types of encoding and steganography that must each be decoded to arrive back at the original version of the hidden text 2;
4. The above steps are repeated to provide the desired number of iterations/layers.
5. Once the final iteration is complete the file may then, in accordance with some embodiments, go through a lossless compression process. This provides the advantage that the file is reduced and thus requires fewer resources for transmission and/or storage, increasing efficiency, reducing blockchain fees required in relation to the transaction, and enabling insertion of the data into the blockchain ledger even if there are limits imposed on block or transaction sizes;
6. The compressed file or the raw final encoded layer from step 4 (i.e. altered stego text 2a in FIG. 2) is communicated to a recipient using a chosen communication medium. The communication channel may be an insecure channel such as the internet because the secret data has been encoded and hidden more than once so its detection and/or access is difficult if not intractable;
   In a preferred embodiment, this step is performed via publication to a blockchain 7. To do this, the altered cover file 2a is provided in a blockchain transaction 6 which is submitted to an associated blockchain network 7. Although the blockchain may be publicly inspected, the hidden data cannot be readily identified due to the steganography that has been applied.
   The skilled person will readily understand that there are various known techniques which can be used for incorporating a portion of data, or a reference to a portion of data, into a blockchain transaction and any such known technique(s) may be used for inserting the data into the transaction 6.
7. Upon receipt, the recipient decompresses and/or decodes the final layer 2a using password2, which provides previously encoded cover file 1a which may, in turn, be decoded using password1 to arrive at the original secret data 2. The recipient receives the compressed or uncompressed steganography file 1a either directly from their peer or by inspecting the blockchain to identify the transaction 6 which comprises the data 2a. The recipient may spend an output associated with the transaction. At each layer, the steganography algorithm may be applied to extract the hidden data from the encoded cover file.

Thus, each layer of steganography, plus any associated verification/encoding mechanism and compression, provides further security which is more difficult for an intercepting party to overcome and gain unauthorised access to the secret data.

With regard to step 6, the final altered cover file 2a or the compressed file can be recorded in the blockchain transaction 6 via any suitable technique, as shown in FIG. 2a. This may comprise embedding it, or a reference/pointer to it, in metadata in a script of the transaction 6. In embodiments which use a variation of the Bitcoin protocol, the data may be provided after the OP_RETURN opcode, or OP_PUSHDATA may be used, or any other suitable mechanism which provides the functionality required for embedding the image into a blockchain transaction in accordance with a chosen blockchain protocol. Thus, in other protocols, other opcodes or mechanisms may be used to the same effect. The blockchain network 7 and associated protocol may be the Bitcoin blockchain or any variant thereof, or an alternative blockchain protocol/network.

With regard to step 7, the receipt, compression and/or decoding steps may be performed by one or more suitably arranged software components which is provided for execution on one or more computing resources eg laptop, server, mobile phone etc. The software component(s) may include a digital wallet. The encoding, compression and/or transmission steps may also be performed by the same or a corresponding software component provided on the same or a corresponding computing resource. The software component and/or computing resource may be associated with a user. Further information relating to illustrative system components is provided below.

### 2. Split Image Steganography

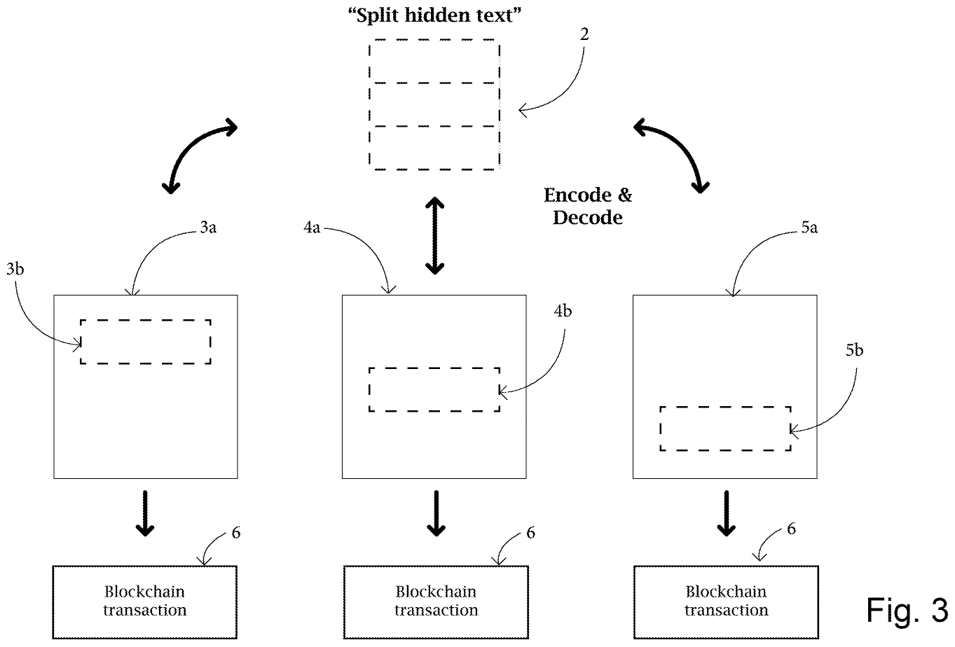

Turning to FIG. 3, another aspect of the invention is now described for yet further enhancement of security. This technique may be used in combination with, or instead of, the first aspect described above in the section entitled “picture-in-picture”. Implementations which use a combination of the two aspects will provide a further still enhancement of security.

In accordance with this aspect, the secret data 2 is split into multiple parts (or “shares”). These are shown as 3b, 4b and 5b in FIG. 3. Share splitting techniques are known in the art. For example, Shamir's Secret Sharing Scheme (4S) can be used https://en.wikipedia.org/wiki/Shamir %27s_Secret_Sharing. In accordance with the splitting scheme, the secret is split into shares which, whether of a fixed or uniform size or otherwise, must be combined in order to reconstruct the original secret.

Shares of the secret data 3b, 4b, 5b are then embedded into separate cover files 3a, 4a, 5a. In one or more embodiments, each share is hidden in a different, respective cover file and each cover file is provided in association with a different transaction on the blockchain.

This enhances security as a would-be attacker would need to identify different cover files and transactions. A steganography algorithm is applied to each share to hide and embed it into a respective cover file. The altered cover file may then be encoded using an encoding algorithm. In this way, a plurality of encoded, altered cover files is generated, each comprising a hidden portion of the secret data. This plurality of encoded, altered cover files can be compressed together or individually and can then be communicated separately to a single recipient or multiple recipients, via any suitable communication vehicle. Compression can provide advantages such as, but not limited to, reducing the amount of resources such as data storage required to accommodate the image on the blockchain, reducing blockchain fees required in relation to the transaction that contains the image, and enabling insertion of the data into the blockchain ledger even if there are limits imposed on block or transaction sizes. According to a preferred embodiment, however, these can be put independently onto a blockchain via one or more transactions (TXs). As above, the cover files can be provided in or by the transaction(s) via any suitable method.

As described above, shares of the secret data can be encrypted prior to being embedded in their respective cover files, using any known and suitable encryption technique. Different shares of the secret data and/or cover files can be associated with a verification element (e.g. password, cryptographic key, biometric data, PIN etc) such that a user is required to provide the pre-determined verification element before being able to gain access to the share/cover file. As different shares can be sent to different recipients, different verification element(s) may be associated with some or all of the shares/cover files. In this way, security is further enhanced.

A repository or resource may be maintained to record and/or store data relating to the associated shares and other related data. The data in the repository enables a record to be kept of the association between the shares and/or secret data. It may also store data relating to which user(s) have authorisation to access the various shares and may include data relating to verification element(s) associated with authorised users. Therefore, reference can be made to the repository to determine which shares and/or cover files comprise the secret data. Additionally or alternatively, the same or a different repository may be used to store/record data relating to which blockchain transaction(s) the hidden data, its shares and/or cover texts are provided in on the blockchain. This may include metadata provided in one or more blockchain transactions, or a transaction ID, or a metanet reference/identifier etc.

One or more cover texts comprising at least a portion of a hidden secret text may be provided within or in association with a token provided in a blockchain transaction.

The repository may comprise a Distributed Hash Table (DHT), database or other computer-implemented storage facility. This may be provided off-chain or the association may be recorded via an on-blockchain arrangement including, but not limited to, via the methods disclosed herein.

Using this approach, then, encoded data can be split across multiple cover files such as images. When reversing the process, all steganography texts/images (shares) must be present and decoded for the secret data to be discovered and reconstructed. The decoding of each cover file is performed using the same or associated decoding steganography algorithm that was used to encode it. The same, or different, steganography algorithms may be applied to respective cover files. If different steganography algorithms are used for respective shares of the secret data (and also for repeated “layers” per share) then security is further enhanced.

This splitting approach provides numerous technical advantages, including the provision of a more flexible and secure solution because different portions of the secret data can be stored, accessed and transmitted separately, and a would-be interceptor would need to identify all of the transactions/cover files which contain the secret data, and then be able to overcome the steganographic algorithm, and also satisfy or circumvent the verification mechanism eg password/cryptographic encryption. Such a solution could be used for secure back-up storage of the secret data as one or more shares could be stored by an authorised, trusted party and provided upon request in the event that the data needs to be recovered from storage.

In Use

One or more embodiments of the present disclosure utilise steganography in public in an unconventional manner and, advantageously, enable securing of sensitive data in a public domain. Technical benefits flowing from the invention include, but are not limited to, an increase in the amount of search space a would-be attacker has to cover to even be able to see or detect the embedded, hidden data before having to overcome the encryption. We now provide an illustration of an embodiment in use, wherein a disclosed method is provided as a service by a provider for a user who wishes to store and/or communicate a portion of secret data. The method may comprise a sender and at least one recipient.

A non-exhaustive, illustrative list of how access could be distributed throughout the number of participants is now provided:
Even if an attacker has access to the cover data containing the hidden data, the attacker does not have
   Access to the user's keys; the key is used to encrypt the secret data before it is hidden; the same or different keys may be used for encrypting and encoding purposes
   Information as to which cover files and/or hidden data are related to which users, if any
   The number of levels of access each file/data combination has, if any
A user has
   User Private Keys
   User Public Keys
   Service Public Keys
   In some embodiments, the user may have blockchain transaction(s) or a hash table of transactions/files needed for the disclosed process
A service/business has
   Service Private Keys
   Service Public Keys
   User Public Keys
   Might have access to transaction(s) or hash table of transactions/files needed
A steganography service provider has
   Keys relating to the Steganographic process (algorithm) that has been or will be used to store data on the blockchain in encoded form.

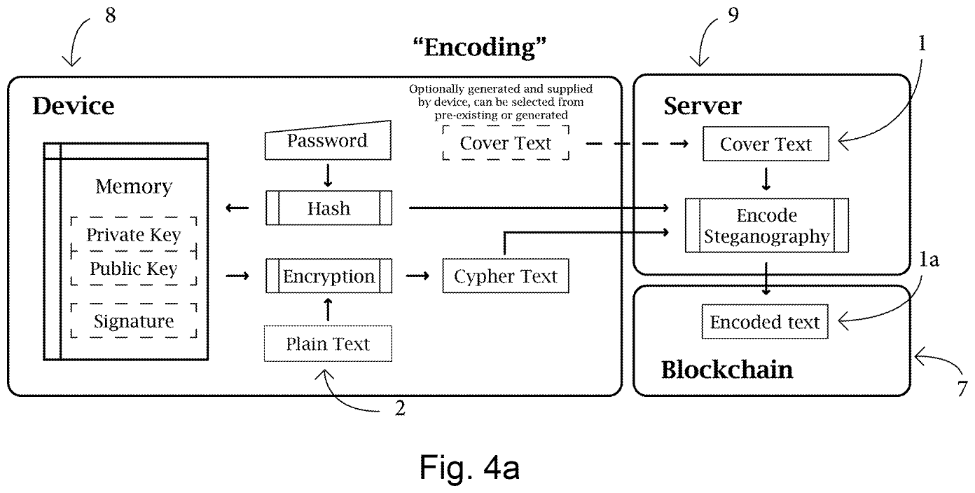

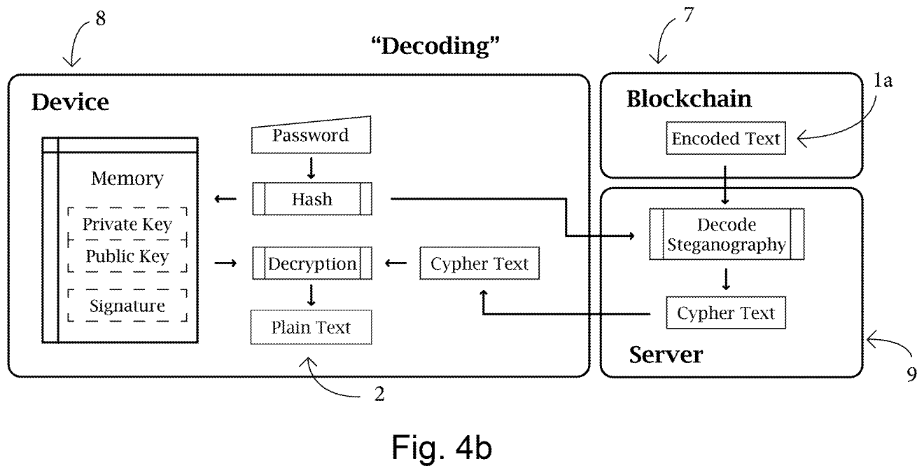

In FIGS. 4a and 4b, such a system is shown which may be used for implementation of one or more embodiments of the disclosure described above. The illustrative system of FIG. 4 comprises a user device 8 arranged to store at least one public and private cryptographic key pair in long term and/or volatile memory, and at least one password eg password1 and/or password2 of FIGS. 2 and 2a. The password(s) may be associated with an individual, user, group or node in a network or system. In some embodiments, the password/association details may be stored in a repository. The device 8 comprises a digital wallet which is operative to generate, receive and process cryptocurrency transactions.

As shown in the illustration of FIG. 4a, the device 8 applies the password to the cover text 1. The cover text may be selected from some pre-existing text(s) or may be generated for the purpose of transmitting the secret data. The device 8 also uses the cryptographic key to encrypt the secret data (plain text) and possibly the cover text to produce the cypher text, which it sends, possibly via an encrypted communications channel, to a server 9 which provides a steganography service. The server 9 applies one or more of the novel steganography technique(s) described above to the decrypted cover text 1, to produce the encoded result and embeds it in a blockchain transaction (Tx) 6. The server (or the device 8, or another party) then submits the transaction to the blockchain network for inclusion in the blockchain ledger.

As shown in FIG. 4b, the process can also be applied in reverse, in order to decode data which has been encoded using one or both of the novel steganography techniques of the disclosure. In the decoding process, the server 9 obtains the encoded data from the transaction 6 on the blockchain 7. It uses the steganography algorithm to decode the encoded data, thus providing the cypher text. It sends the cypher text to the device 8, which uses the password and cryptographic key to decrypt the cypher text and provide the plain text.

In other embodiments, however, all of the method steps may be performed on a single device e.g. the user's device or distributed across various system components or nodes.

Compression/Decompression

Embodiments of the disclosure may be combined with data compression and decompression techniques to provide further technical advantages, including the reduction in on/off chain storage resources and transmission facilities. Preferably, the compression algorithm is a lossless compression algorithm and therefore the steganography/data hiding effects are not compromised or lost. Therefore, by incorporating lossless compression/decompression into the process one is able to improve efficiency without degrading the security benefits that flow from the steganography technique(s).

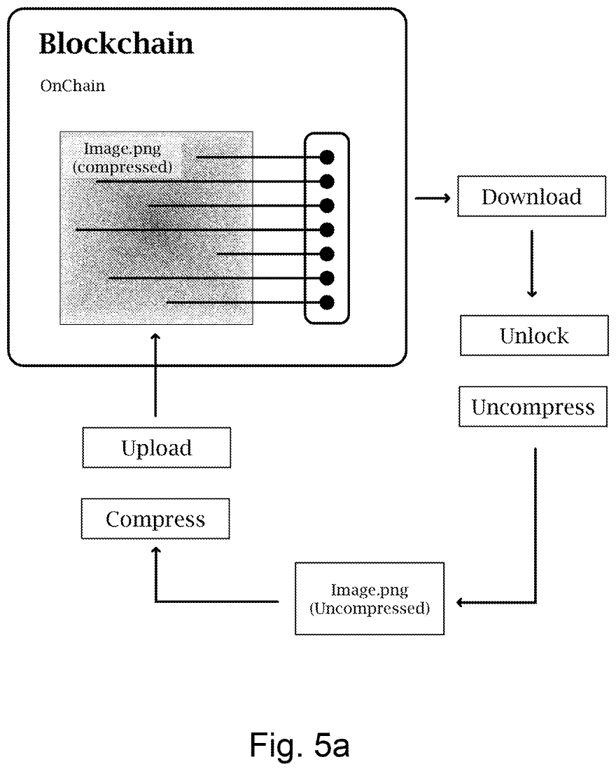

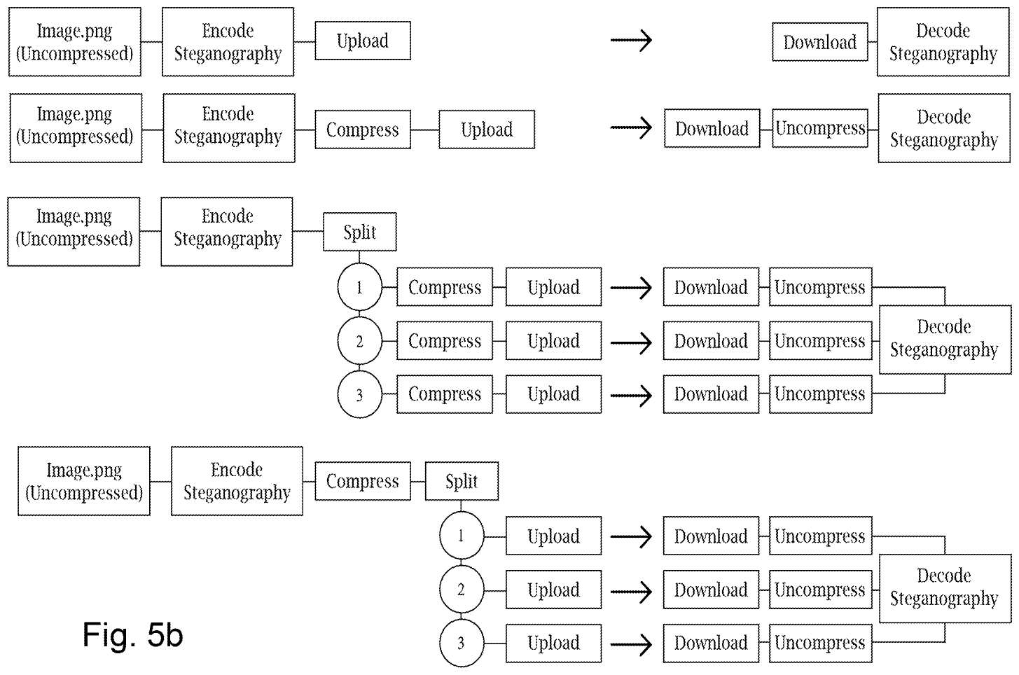

The incorporation of compression techniques is illustrated in FIGS. 5a and 5b. FIG. 5a shows how an uncompressed cover file (image.png) can be compressed and uploaded to the blockchain in a compressed form. From the blockchain, it can then be downloaded, unlocked (or decoded) and then decompressed to reverse the original compression algorithm.

The compression algorithm can be applied to the cover text or plain (secret) text before or after the steganography technique is applied, but before the file is inserted into the blockchain transaction and submitted to the ledger.

FIG. 5b shows how the compression/decompression steps can be applied to the embodiments disclosed herein in a variety of forms and orders. Note that these examples are not an exhaustive or limiting list of the ways or order in which the compression/decompression techniques can be applied to the disclosed processes.

For example, in the “split image” approach described above, one, some or all of the shares may be compressed. Additionally or alternatively, one, some or all of the “layers” of steganography may comprise the use of compression/decompression.

### Terminology

Herein, a verification element may be a password, biometric data, identifier of some type, cryptographic key or any type of item which can be used to validate the identity of a (human or machine-implemented) user. Successful verification of the identity may enable access to a controlled resource whereas failure to verify the identity may block or prohibit access.

In this document we use the term ‘blockchain’ to include all forms of electronic, computer-based, distributed ledgers. These include consensus-based blockchain and transaction-chain technologies, permissioned and un-permissioned ledgers, shared ledgers, public and private blockchains, and variations thereof. The most widely known application of blockchain technology is the Bitcoin ledger, although other blockchain implementations have been proposed and developed. While Bitcoin may be referred to herein for the purpose of convenience and illustration, it should be noted that the disclosure is not limited to use with the Bitcoin blockchain and alternative blockchain implementations and protocols fall within the scope of the present disclosure. The term “user” may refer herein to a human or a processor-based resource. The term “Bitcoin” is used herein to include any version or variation that derives from or is based on the Bitcoin protocol.

A blockchain is a peer-to-peer, electronic ledger which is implemented as a computer-based decentralised, distributed system made up of blocks which in turn are made up of transactions. Blockchain protocols may limit the size of blocks that can be processed via the network, giving rise to bottlenecks, high transaction fees, delays in processing and scalability issues. Such limits give rise to restrictions on the number and size of transactions that can be handled and the type of data that they carry.

Each transaction (Tx) is a data structure that encodes the transfer of control of a digital asset between participants in the blockchain system, and includes at least one input and at least one output. Each block contains a hash of the previous block to that blocks become chained together to create a permanent, unalterable record of all transactions which have been written to the blockchain since its inception. Transactions contain small programs known as scripts embedded into their inputs and outputs, which specify how and by whom the outputs of the transactions can be accessed. On the Bitcoin platform, these scripts are written using a stack-based scripting language.

In order for a transaction to be written to the blockchain, it must be “validated”. Network nodes (miners) perform work to ensure that each transaction is valid, with invalid outputs rejected from spending but accepted by the network. Software clients installed on the nodes perform this validation work on an unspent transaction (UTXO) by executing its locking and unlocking scripts. If execution of the locking and unlocking scripts evaluate to TRUE, the transaction is valid and the transaction is written to the blockchain. Thus, in order for a transaction to be written to the blockchain, it must be i) validated by the first node that receives the transaction—if the transaction is validated or invalid, the node relays it to the other nodes in the network either as a valid transaction or as a notification that it is invalid; and ii) added to a new block built by a miner; and iii) mined, i.e. added to the public ledger of past transactions.

Once stored in the blockchain as a UTXO, a user can transfer control of the associated resource to another address associated with an input in another transaction. This is often performed using a digital wallet which stores public and private cryptographic keys. The wallet is arranged to track ownership of resources, tokens and assets etc. associated with a user, receive or send cryptocurrencies, transfer tokens which may relate to cryptocurrencies or other types of resource.

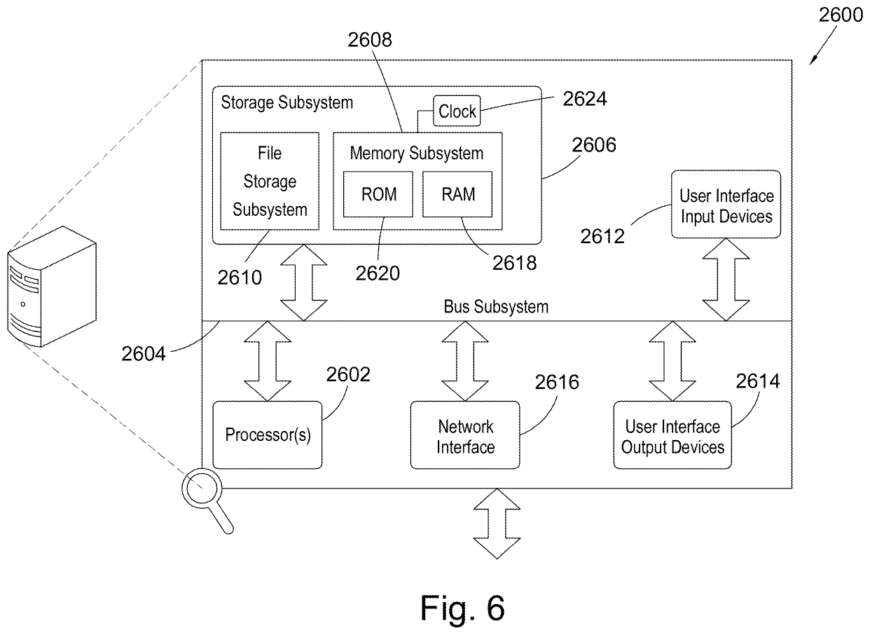

Turning now to FIG. 6, there is provided an illustrative, simplified block diagram of a computing device 2600 that may be used to practice at least one embodiment of the present disclosure. In various embodiments, the computing device 2600 may be used to implement any of the systems illustrated and described above. For example, the computing device 2600 may be configured for use as a data server, a web server, a portable computing device, a personal computer, or any electronic computing device. As shown in FIG. 6, the computing device 2600 may include one or more processors with one or more levels of cache memory and a memory controller (collectively labelled 2602) that can be configured to communicate with a storage subsystem 2606 that includes main memory 2608 and persistent storage 2610. The main memory 2608 can include dynamic random-access memory (DRAM) 2618 and read-only memory (ROM) 2620 as shown. The storage subsystem 2606 and the cache memory 2602 and may be used for storage of information, such as details associated with transactions and blocks as described in the present disclosure. The processor(s) 2602 may be utilized to provide the steps or functionality of any embodiment as described in the present disclosure.

The processor(s) 2602 can also communicate with one or more user interface input devices 2612, one or more user interface output devices 2614, and a network interface subsystem 2616.

A bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilize multiple busses.

The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a network such that the data technician may be able to transmit data to the device and receive data from the device while in a remote location, such as a data centre.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600.

The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate.

The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. For example, the main memory 2608 and cache memory 2602 can provide volatile storage for program and data. The persistent storage 2610 can provide persistent (non-volatile) storage for program and data and may include flash memory, one or more solid state drives, one or more magnetic hard disk drives, one or more floppy disk drives with associated removable media, one or more optical drives (e.g. CD-ROM or DVD or Blue-Ray) drive with associated removable media, and other like storage media. Such program and data can include programs for carrying out the steps of one or more embodiments as described in the present disclosure as well as data associated with transactions and blocks as described in the present disclosure.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fibre-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 6 is intended only as a specific example for purposes of illustrating the preferred embodiment of the device. Many other configurations having more or fewer components than the system depicted in FIG. 6 are possible.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer-implemented method for secure transfer and/or storage of secret data hidden in an encoded cover text, the method comprising the steps:
using a data hiding algorithm to embed the encoded cover text in at least one further cover text to provide at least one further encoded cover text;
and
providing the at least one further encoded cover text in a blockchain transaction.

2. A method according to claim 1 and further comprising the step of:
submitting the blockchain transaction to a blockchain network.

3. A method according to claim 1 and further comprising the step of:
associating a verification element with the secret data, first cover text and/or at least one further cover text to require provision of the verification element before access is granted.

4. A method according to claim 1 and comprising the step of:
encrypting the secret data, the cover text, the first encoded cover text, the at least one further cover text and/or the at least one further encoded cover text prior to using the data hiding algorithm.

5. A method according to claim 1 and comprising the step of:
accessing the at least one further encoded cover text from a blockchain transaction;
using the same or a different data hiding algorithm to decode the first or the further encoded cover text;
and/or
providing the verification element to gain access to the secret data, first cover text and/or at least one further cover text.

6. A method according to claim 1 wherein the secret data is provided in the blockchain transaction:
i) as a portion of metadata;
ii) after an OP_PUSHDATA instruction, or OP_RETURN instruction or a script opcode that marks a transaction output (UTXO) as invalid;
iii) as a reference to an off-blockchain resource.

7. A method according to claim 1, and comprising the step of:
applying a compression algorithm to the cover text, the encoded cover text, the at least one further cover text and/or the at least one further encoded cover text; preferably wherein the compression algorithm is a lossless compression algorithm.

8. A computer-implemented method for secure transfer of secret data hidden in an encoded cover text of a blockchain transaction, the method comprising the steps:
using a data hiding algorithm to decode the encoded cover text and provide a decoded cover text;
and
using the same or another data hiding algorithm decode the decoded cover text to provide the secret data or a further decoded cover text.

9. A method according to claim 8 and further comprising the step of:
accessing the encoded cover text from the blockchain transaction;
providing a verification element to gain access to the secret data, encoded cover text, decoded cover text and/or at least one further decoded cover text;
and/or
decrypting the secret data, the encoded cover text, the decoded cover text and/or the at least one further decoded cover text prior to using the data hiding algorithm.

10. A method according to claim 8 wherein the secret data is provided in the blockchain transaction:
i) as a portion of metadata;
ii) after an OP_PUSHDATA instruction, and OP_RETURN instruction or a script opcode that marks a transaction output (UTXO) as invalid;
and/or
iii) as a reference to an off-blockchain resource.

11. A method according to claim 8 and comprising the step of:
applying a decompression algorithm to the encoded cover text, the decoded cover text; and/or the further decoded cover text.

12. A computer-implemented method for secure transfer of secret data, the method comprising the steps:
splitting the secret data into a plurality of shares;
using at least one data hiding algorithm to embed at least two of the plurality of shares in at least one cover text;
providing the at least one cover text in at least one blockchain transaction.

13. A method according to claim 12 and further comprising the step of:
storing, in a repository: data relating to the secret data, the plurality of shares, the at least one blockchain transaction and or access permissions for the plurality of shares.

14. A method according to claim 12 and further comprising the step of:
encrypting at least one of the plurality of shares.

15. A method according to claim 12 and further comprising the step of:
associating at least one verification element with at least one of the plurality of shares of the secret data and or at least one cover text to require provision of the verification element before access is granted.

16. A method according to claim 12 and comprising the step of:
applying a compression/decompression algorithm to the at least one cover text and/or secret data.

17. A method according to claim 12 and further comprising the step of generating or obtaining the secret data by:
i) obtaining or accessing the at least one cover text from the at least one blockchain transaction;
ii) using the at least one data hiding algorithm to decode the at least one cover text to provide the at least two shares; and/or
iii) reconstructing the secret data from the at least two shares.

18. A computer-implemented system comprising:
a processor; and
memory including executable instructions that, as a result of execution by the processor, causes the system to perform any embodiment of the computer-implemented method as claimed in claim.

19. A non-transitory computer-readable storage medium having stored thereon executable instructions that, as a result of being executed by a processor of a computer system, cause the computer system to at least perform an embodiment of the method as claimed in claim 1.
